(19) United States
(12) Patent Application Publication
(10) Pub. No.: US 2001/0033322 A1
(43) Pub. Date: Oct. 25, 2001

(54) Image data control unit for SLM-based photofinishing system

(76) Inventors: William M. Bommersbach, Richardson, TX (US); Donald C. Whitney, Plano, TX (US); Frederick C. Wedemeier, Richardson, TX (US); Stephen W. Marshall, Richardson, TX (US)

Correspondence Address: TEXAS INSTRUMENTS INCORPORATED, P O BOX 655474, M/S 3999, DALLAS, TX, 75265

(21) Appl. No.: 09/765,232

(22) Filed: Jan. 18, 2001

Related U.S. Application Data
(60) Provisional application No. 60/177,505, filed on Jan. 21, 2000.

(51) Int. Cl. B41J 2/47

(52) U.S. Cl. 347/232; 347/239; 347/240

(57) ABSTRACT

An image data control unit for an SLM-based photofinishing system. The control unit is typically used with a photofinishing system in which the SLM provides an exposure region that is smaller than the image to be printed or otherwise produced. Thus, the output image is in motion relative to the SLM, such as by moving the photographic medium under the SLM. To meet system throughput requirements, such systems use an exposure algorithm that exposes each line of the output image with multiple rows of the SLM. The control unit implements the exposure algorithm by reformatting source image data and loading the SLM with SLM settings. It synchronizes these functions to the motion of the photographic medium upon with the image is printed.

### BACKGROUND OF THE INVENTION

Spatial light modulators (SLMS) have found application in many fields, a significant one of which is digital printing. In general, an SLM is an array of light-emitting, light-transmitting, or light-reflecting elements, which are individually addressable, usually with electronic signals. Many SLMs are binary, having an addressing scheme that switches its elements to either an “on” or “off” state to form the image. A characteristic of SLMs is that there is no scanning—all pixels are activated at substantially the same time to generate the entire image or a two-dimensional block of the image, depending on the size of the image and the SLM.

One type of SLM is a digital micro-mirror device (DMD). The DMD has an array of hundreds or thousands of tiny tilting mirrors. To permit the mirrors to tilt, each is attached to one or more hinges mounted on support posts and each is spaced by means of an air gap over underlying addressing circuitry. The addressing circuitry provides electrostatic forces, which cause each mirror to selectively tilt.

For printing applications, the DMD is addressed with exposure data, and in accordance with the data, light is selectively reflected or not reflected from each mirror to a photosensitive surface. In the case of electrophotographic printing, the photosensitive surface is an OPC (organic photoconductive drum) or other photoreceptor, which then transfers a latent image to paper or other printable media. In the case of photofinishing, the photosensitive surface is the photosensitive paper that will bear a printed photograph.

For all types of digital printing, SLMs have performed well in terms of print quality. Depending on the application, SLM characteristics and operation may be optimized according to consumer expectations of how the output should best appear and according to industry demands. For example, for photofinishing applications, the resolution must be sufficiently high to compete with conventional analog photofinishing, yet the process must also be fast enough to make using SLMs a cost effective alternative.

SLM-based photographic printers (photofinishers) remained relatively uncommon and very expensive. However, as the quantity and quality of digital image source material increases, the demand for digital photographic-quality hardcopy output devices is also increasing. Unfortunately, available hardcopy photographic-quality output devices cannot output quality images cheap enough and fast enough to exploit potential markets. What is needed is a photographic-quality hardcopy device capable of producing images at a cost and speed acceptable for the volume photofinishing market and convenient enough for the consumer market.

### SUMMARY OF THE INVENTION

One aspect of the invention is an image data control unit for an SLM-based photofinishing system. The photofinishing system produces images based on source pixel data, each line of the image being exposed with multiple rows of the SLM, one new line beginning exposed during each exposure phase, and one line completing exposure during each exposure phase. The control unit has a row buffer that stores a number of rows of source pixel data, each value of the source pixel data representing a red, green, and blue greyscale level. A look-up memory stores a table of SLM settings, indexed by color, greyscale levels, and exposure phases. A controller generates an exposure phase signal for each exposure phase, each exposure phase signal providing access to the look-up memory to obtain at least one SLM setting value corresponding to a greyscale value and an exposure phase, for each pixel in each of the multiple rows of the SLM. The controller also generates control signals for operating the SLM. A settings buffer receives settings from the look-up memory and stores them for delivery to the SLM.

The control unit may be used with various photofinishing configurations, such as with color wheel systems or fixed color filter (multiple SLM) systems. Nor is the control unit limited to any particular exposure algorithm. It may implement exposure algorithms based on any combination of row integration, pulse width modulation, and intensity modulation.

The control unit provides precise high-resolution light modulation for printing to a photosensitive medium. The prints may have a gray level depth of 12 bits or more per pixel. A typical print output is 320 dpi at 8 inches per second, which is sufficient for industry demands. This may be achieved with an SLM having only have a modest number of rows.

### BRIEF DESCRIPTION OF THE DRAWINGS

FIG. 1 illustrates a portion of a digital micro mirror device (DMD) array.

FIG. 2 illustrates a single mirror element of the DMD of FIG. 1.

FIG. 3 is a diagram of the basic principles of the exposure phase of digital printing with an SLM.

FIG. 4 illustrates the concept of row integration, one modulation method that may be incorporated into an exposure algorithm.

FIG. 5 illustrates the system of FIG. 3, but with the SLM providing concurrent images for different colors, for producing color prints.

FIG. 6 illustrates the system of FIG. 3, but with a color wheel for producing color prints.

FIG. 7 illustrates the image control unit of FIGS. 3, 5, and 6.

FIG. 8 illustrates the operation of the image control unit.

FIG. 9 illustrates an example of a frame buffer for the image control unit.

FIG. 10 illustrates an example of the reformatting elements (row buffer, look-up table, and settings buffer) of the image control unit.

FIG. 11 illustrates an example of the controller for the image control unit.

FIG. 12 illustrates the generation of the look-up table for the image control unit.

### DETAILED DESCRIPTION OF THE INVENTION

U.S. patent Ser. No. 09/221,517, entitled “Photofinishing Utilizing Modulated Light Source Array”, to W. E. Nelson et al. and assigned to Texas Instruments Incorporated, describes various aspects of photofinishing using spatial light modulators (SLMs). That patent application is incorporated herein by reference.

The following description is primarily directed to exposure methods and associated equipment for implementing SLM-based photofinishing systems. As explained below, the photofinishing system has an “exposure system”, which includes the SLM and related components as well as an image data control unit that formats the data into a form useable by the SLM. More specifically, the image control unit generates various control signals required to implement an exposure algorithm.

The techniques described herein provide high speed photofinishing with gray scale output to high bit depths. For example, an exposure algorithm is described herein whereby each pixel of the output image may have up to 2¹² (4096) levels of greyscale. As explained below, this is accomplished by using 192 rows of the SLM to expose each row of pixels, and by pulse width modulating each of the 192 exposures per pixel with one of four different pulse widths.

The following description is in terms of a separate light source and SLM, specifically a tungsten halogen lamp and a micromechanical digital micromirror device (DMD) modulator. However, the invention may be implemented with other types of SLMs. A “spatial light modulator”, sometimes referred to as a “modulated light source”, as used herein, may be any light source or combination of light source and modulator that is capable of producing a beam of light with a cross-section having individually modulated regions. The intensity of each individually modulated region, also called a cell or element, determines the optical density of a pixel on a photosensitive medium.

Other types of light modulators are liquid crystal devices (LCDs), other light sources, such as light emitting diodes (LEDs) arc lamps, and lasers, or combined modulator/light sources such as LEDs and lasers. These types of SLMs are also amenable to the disclosed photofinishing system, modulation techniques, and image control unit. Some of these sources can be intensity modulated to provide an additional modulation depth; some can only operate as continuous wave (CW) sources.

### Operation and Structure of DMD

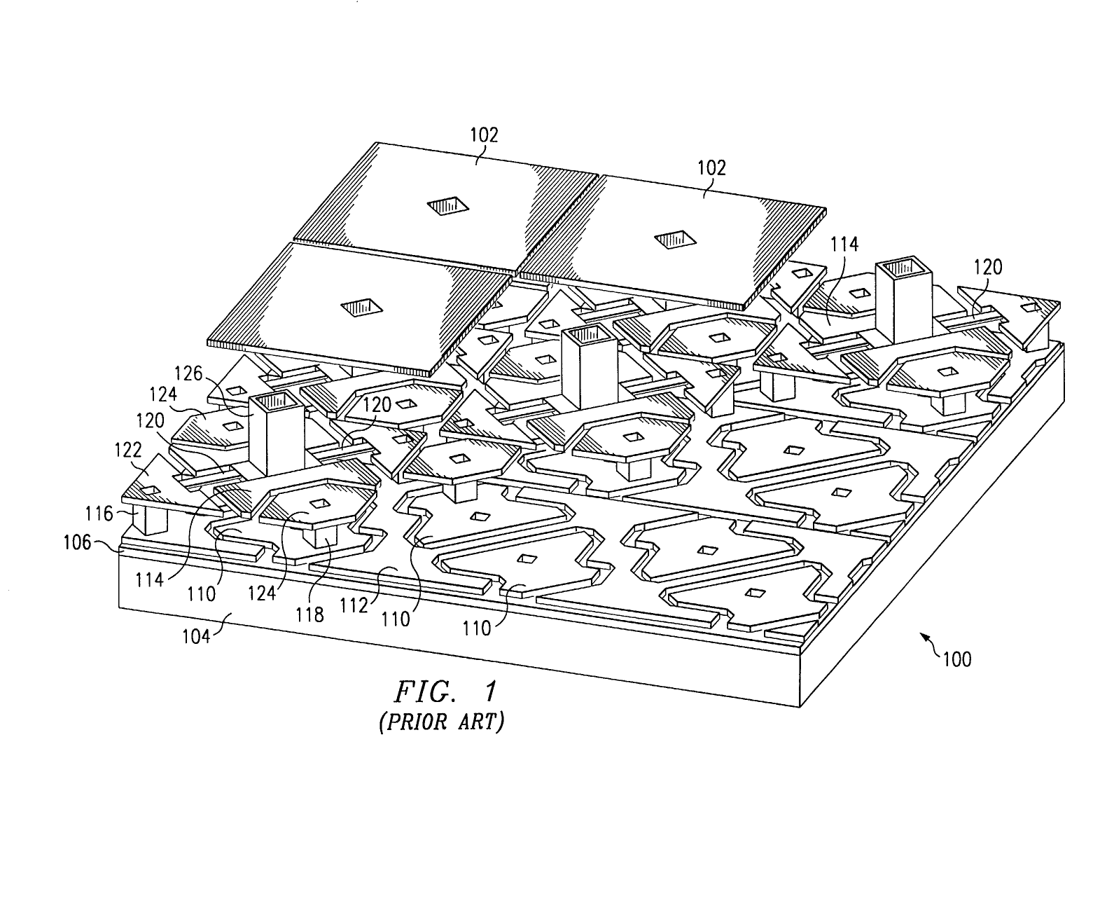

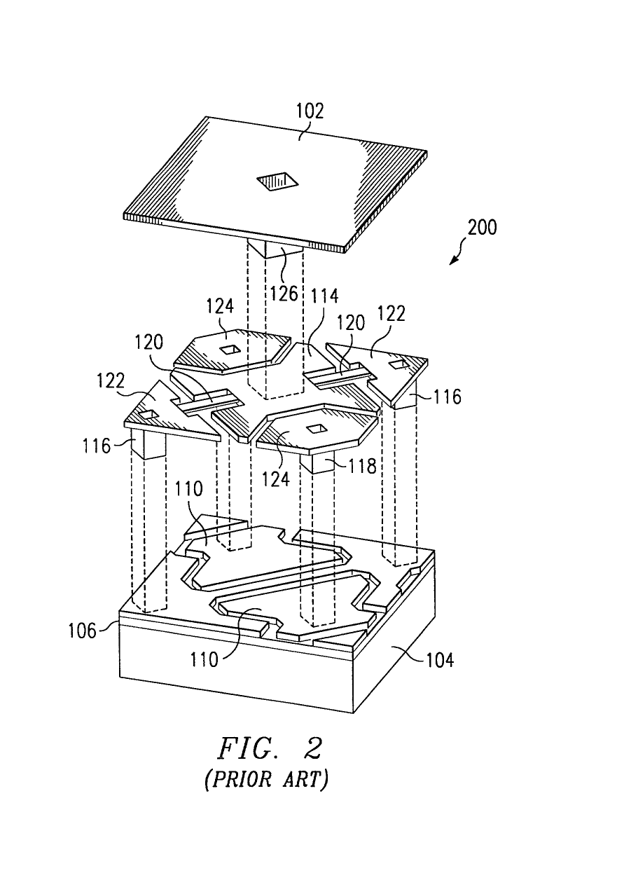

FIG. 1 illustrates a portion of a DMD array 100 and FIG. 2 illustrates a single mirror element 200. The DMD embodiment of FIGS. 1 and 2 is known as a “hidden-hinge” DMD, because each mirror element is characterized by the fabrication of the mirror on a support (referred to herein as a “spacer via”) above torsion beams that permit the mirror to tilt. As explained below, the elevated mirror covers the torsion beams, torsion beam supports, and a rigid yoke connecting the torsion beams and mirror support. An advantage of the hidden-hinge design is an improved contrast ratio of images produced by the DMD. Contrast ratios of several hundred to one are now readily achieved.

Referring to FIG. 1, a typical hidden-hinge DMD 100 is a two-dimensional array of DMD elements. This array often includes more than a thousand DMD rows and columns of DMDs. FIG. 1 shows a small portion of a DMD array with several mirrors 102 and spacer vias 126 removed to show the underlying mechanical structure.

DMD 100 is fabricated on a semiconductor, typically silicon, substrate 104. Electrical control circuitry is typically fabricated in or on the surface of the semiconductor substrate 104 using standard integrated circuit process flows. This circuitry typically includes, but is not limited to, a memory cell associated with and typically underlying each mirror 102 and digital logic circuits to control the transfer of the digital image data to the underlying memory cells. Voltage driver circuits to drive bias and reset signals to the mirror superstructure may also be fabricated on the DMD structure, or may be external to the DMD. Image processing and formatting logic is also formed in the substrate 104 of some designs.

Older DMD configurations used a split reset configuration which allows several DMD elements to share one memory cell. Split reset is enabled by the bistable operation of a DMD, which allows the contents of the underlying memory to change without affecting the position of the mirror 102 when the mirror has a bias voltage applied. Newer generations of DMDs, however, have evolved to non-split reset architectures that use one memory cell for each DMD element. For the purposes of this description, addressing circuitry is considered to connections and shared memory cells, used to control the direction of rotation of a DMD mirror.

The silicon substrate 104 and any necessary metal interconnection layers are isolated from the DMD superstructure by an insulating layer 106, which is typically a deposited silicon dioxide layer on which the DMD superstructure is formed after the silicon dioxide layer is planarized and polished to a high degree of flatness. Vias are opened in the oxide layer to allow electrical connection of the DMD superstructure with the electronic circuitry formed in the substrate 104.

The first layer of the superstructure is a metalization layer, typically the third metalization layer, often called M3. Two metalization layers, often called M1 and M2, are typically required to interconnect the circuitry fabricated on the substrate. This metalization layer is deposited on the insulating layer and patterned to form address electrodes 110 and a mirror bias connection 112. Some micromirror designs have landing electrodes that are separate and distinct structures but are electrically connected to the mirror bias connection 112. Landing electrodes limit the rotation of the mirror 102 and prevent the rotated mirror 102 or hinge yoke 114 from touching the address electrodes 110, which have a voltage potential relative to the mirror 102. If the mirror 102 contacted the address electrodes 110, the resulting short circuit could fuse the torsion hinges 116 or weld the mirror 102 to the address electrodes 110, in either case destroying the DMD. Since the same voltage is always applied to both the landing electrodes and the mirrors 102, the mirror bias connection and the landing electrodes are preferably combined in a single structure when possible. The mirror bias connection 112 typically includes regions called landing sites which mechanically limit the rotation of the mirror 102 or a hinge yoke 144. These landing sites are often coated with a material chosen to reduce the tendency of the mirror 102 and torsion hinge yoke 144 to stick to the landing site.

Mirror bias/reset voltages travel to each mirror 102 through a combination of paths using both the mirror bias/reset metalization 112 and mirrors and torsion beams of adjacent mirror elements. Split reset designs require the array of mirrors to be subdivided into multiple subarrays each having an independent mirror bias connection. The landing electrode/mirror bias 112 configuration shown in FIG. 1 is ideally suited to split reset applications since the DMD elements are easily segregated into electrically isolated rows or columns simply by isolating the mirror bias/reset layer between the subarrays.

A first layer of supports, typically called spacer-vias, is fabricated on the metal layer forming the address electrodes 110 and mirror bias connections 112. These spacer vias, which include both hinge support spacer vias 116 and upper address electrode spacer vias 118, are typically formed by spinning a thin spacer layer over the address electrodes 110 and mirror bias connections 112. This thin spacer layer is typically a 1 micrometer thick layer of positive photoresist. After the photoresist layer is deposited, it is exposed, patterned, and deep UV hardened to form holes where the spacer vias will be formed. This spacer layer, as well as a thicker spacer layer used later in the fabrication process, are often called sacrificial layers since they are used only as forms during the fabrication process and are removed from the device prior to device operation.

A thin layer of metal is sputtered onto the spacer layer and into the holes. An oxide is then deposited over the thin metal layer and patterned to form an etch mask over the regions that later will form hinges 120. A thicker layer of metal, typically an aluminum alloy, is sputtered over the thin layer and oxide etch masks. Another layer of oxide is deposited and patterned to define the hinge yoke 114, hinge cap 122, and the upper address electrodes 124. After this second oxide layer is patterned, the two metals layers are etched simultaneously and the oxide etch stops removed to leave thick rigid hinge yokes 114, hinge caps 122, and upper address electrodes 124, and thin flexible torsion beams 120.

A thick spacer layer is then deposited over the thick metal layer and patterned and etched to define holes in which mirror support spacer vias 126 will be formed. This spacer layer is typically a 2 micrometer thick layer of positive photoresist. A layer of mirror metal, typically an aluminum alloy, is sputtered on the surface of the thick spacer layer and into the holes in the thick spacer layer. This metal layer is then patterned to form the mirrors 102 and both spacer layers are removed using a plasma etch. The spacer vias 126 provide a mechanical and electrical connection between mirrors 102 and the underlying metal layer.

The above-described process results in a hole 102a in each mirror 102. As explained below, hole 102a has desirable effects for printing applications. The effect of the hole may be enhanced for electrophotographic printing applications, and may be “flattened” for photofinishing applications.

Once the two spacer layers have been removed, the mirror 102 is free to rotate about the axis formed by the torsion hinge 120. Electrostatic attraction between an address electrode 110 and a deflectable rigid member, which in effect forms the two plates of an air gap capacitor, is used to rotate the mirror structure. Depending on the design of the micromirror device, the rigid member is the torsion beam yoke 114, beam, mirror 102, both the yoke 114 and beam or mirror 102, or a beam attached directly to the torsion beams. The upper address electrodes 124 also electrostatically attract the rigid member.

The force created by the voltage potential is a function of the reciprocal of the distance between the two plates. As the rigid member rotates due to the electrostatic torque, the torsion beam hinges resist with a restoring torque, which is an approximately linear function of the angular deflection of the torsion beams. The structure rotates until the restoring torsion beam torque equals the electrostatic torque, or until the rotation is mechanically stopped by contact between the rotating structure and a stationary portion of the DMD, typically at a rotation of 10° to 12° in either direction. As mentioned above, most micromirror devices are operated in a digital mode wherein sufficiently large bias voltages are used to ensure full deflection of the micromirror superstructure.

Micromirror devices are generally operated in one of two modes of operation. The first mode of operation is an analog mode, sometimes called beam steering, wherein the address electrode is charged to a voltage corresponding to the desired deflection of the mirror. Light striking the micromirror device is reflected by the mirror at an angle determined by the deflection of the mirror. Depending on the voltage applied to the address electrode, the cone of light reflected by an individual mirror is directed to fall outside the aperture of a projection lens, partially within the aperture, or completely within the aperture of the lens. The reflected light is focused by the lens onto an image plane, with each individual mirror corresponding to a location on the image plane. As the cone of reflected light is moved from completely within the aperture to completely outside the aperture, the image location corresponding to the mirror dims, creating continuous brightness levels.

The second mode of operation is a digital mode. When operated digitally, each micromirror is fully deflected in either of the two directions about the torsion beam axis. Digital operation uses a well defined bias voltage to ensure the mirror is fully deflected. Since it is advantageous to drive the address electrode using standard logic voltage levels, a bias voltage, typically a negative voltage, is applied to the mirror metal layer to increase the voltage difference between the address electrodes and the mirrors after addressing the mirrors with a lower, CMOS compatible voltage, typically +5 V. Use of a sufficiently large mirror bias voltage, a voltage above what is termed the collapse voltage of the device, ensures the mirror will deflect to the closest landing electrodes even in the absence of an address voltage. Therefore, by using a large mirror bias voltage, the address voltages need only be large enough to deflect the mirror slightly, and predetermine the deflection direction, e.g. establish the mirror cell as an “off-state” or an “on-state”.

To create an image using the DMD, the light source is positioned at an angle equal to twice the angle of rotation so that mirrors rotated toward the light source reflect light in a direction normal to the surface of the micromirror device and into the aperture of a projection lens—creating a bright pixel on the image plane. Mirrors rotated away from the light source reflect light away from the projection lens—leaving the corresponding pixel dark.

### Overview of Photofinishing Using Spatial Light Modulators

Experimentation has shown that a digital photographic printer should provide images with a resolution of at least 320 dpi and 4096 intensity levels for each of three component colors to be accepted as a viable alternative to traditional photographic processes. Providing 4096 intensity levels requires an intensity word having a size of12 bits per color.

A 4×6 inch print size and the 320 dpi spatial resolution specification requires a 1280×1920 SLM if the entire photograph is to be imaged at one time. Unfortunately, a 1280×1920 SLM is impractical and costly. One solution is to use an SLM having fewer rows and to move the photographic medium past the SLM such that different portions of the image are exposed sequentially. In other words, the SLM scans the photographic medium.

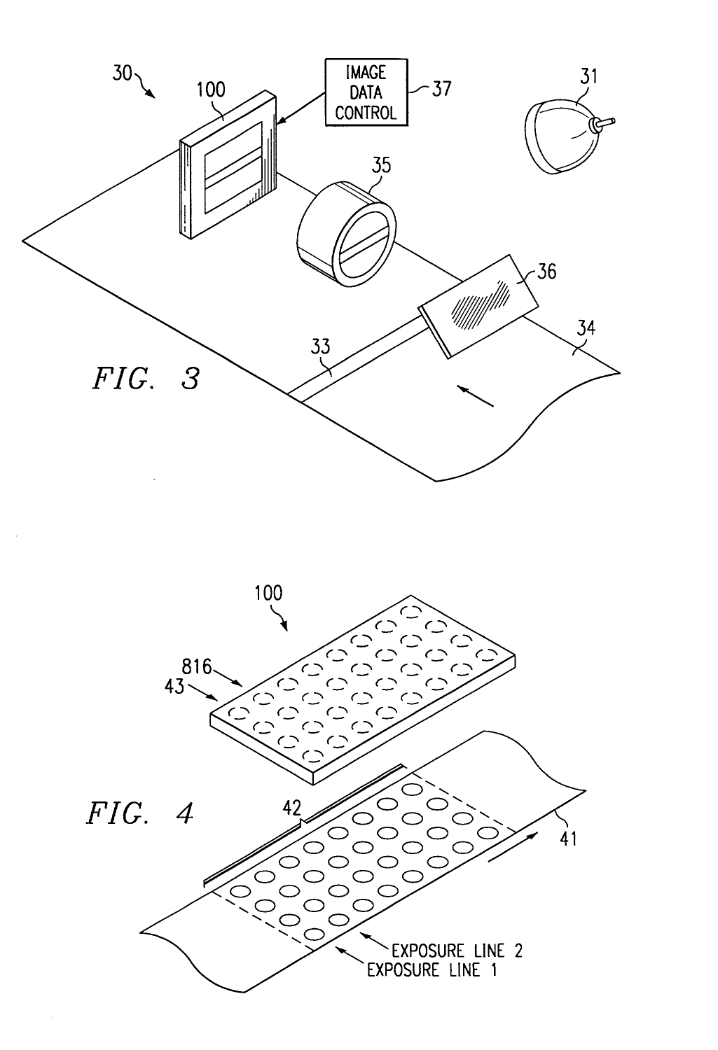

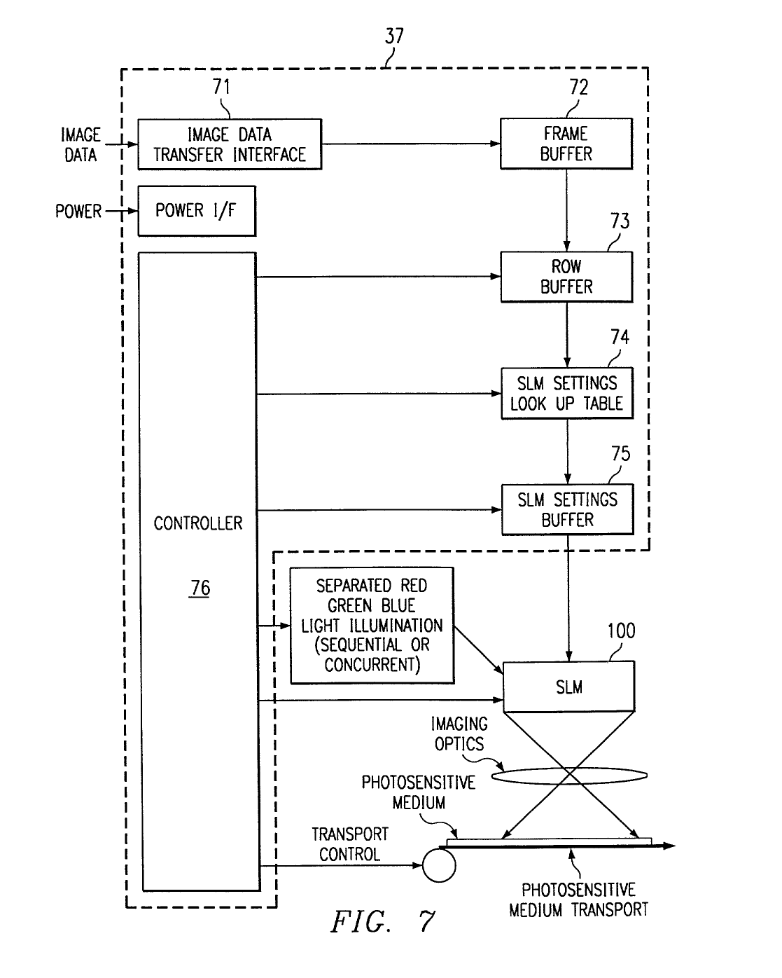

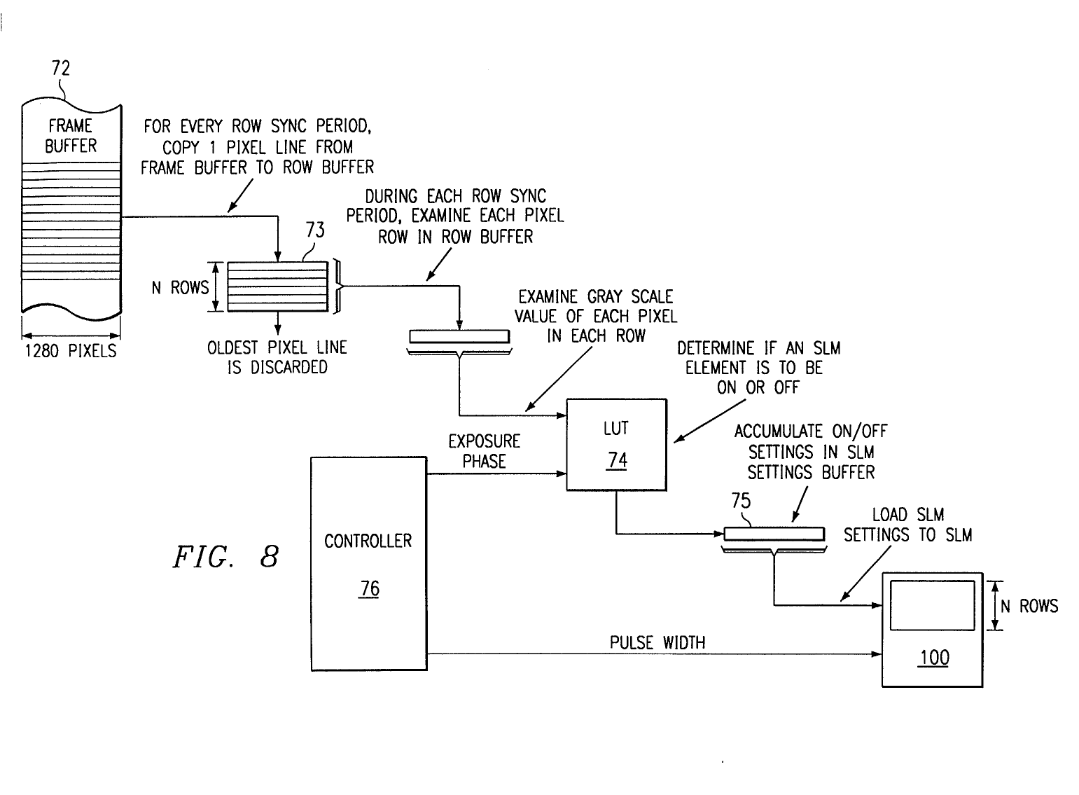

FIG. 3 illustrates an example of the basic elements of the exposure unit 30 of a “scanning” type SLM photofinishing system. A lamp 31 illuminates a strip of a suitably wide SLM 100 to image an exposure region 33 across the width of the photosensitive medium 34. In the example of this description, SLM 100 has a width of at least 1280 elements. Modulated light from the SLM 100 reaches imaging lens 35, and is focused onto the medium 34 after being reflected by suitable optics 36. The photosensitive medium 34 is moved past the exposure region 33 to allow the entire length of the image to be exposed continuously, effectively allowing an unrestricted exposure length in the process (paper motion) direction. As the medium 34 is continuously moved across the exposure region 33, the imaging provided by the SLM 100 is synchronized with its movement. An image data control unit 37 provides data to the SLM 100 that determines which elements are on and which are off for each image frame generated by the SLM 100. Image data control unit 37 is explained below in connection with FIGS. 7-13.

FIG. 3 is shown merely for purposes of illustration and not for purposes of limitation. Instead of moving the photosensitive medium, a scanning mirror may be used. There are many alternative embodiments available to expose the paper. For example, a transmissive modulator or controllable light source is sometimes used in place of the reflective modulator shown. Additionally, alternative embodiments have additional lenses or alternative light paths, or alternative SLM arrays, and can be reflective or transmissive.

In addition to providing an image having at least 320 dpi with 12-bits of greyscale per color, a digital photographic printer must be able to rapidly produce a large number of prints in order to gain acceptance in the photofinishing market. Specifically, the printer should be capable of producing at least several thousand prints per hour. Given the requirement of producing several thousand 4×6 inch photographs each hour, the paper must be exposed at a linear rate of several inches per second. Specifically, to print 4800 4×6 prints per hour implies a process speed of 8″ per second. Given a resolution of 320 lines per inch and a process speed of 8 inches per second, the printer must expose at a rate of 2560 lines each second. This corresponds to an exposure period of 390.625 microseconds for printing each line. This process speed is used herein for purposes of example, and this time for printing each line is referred to as the “row sync” period.

The above-described process speed is not sufficient to permit a line of the image to be fully exposed during one row sync period. The time needed to fully expose a photographic medium depends on the light source as well as the type of photographic medium. For a 150 W Tungsten-Halogen light source at 3200° K. and standard photographic paper, a saturated exposure requires approximately 3 to 5 milliseconds of exposure time. Thus, multiple DMD row sync periods are required to achieve a fully saturated exposure. In addition, a reduction in exposure time from 100% of a row sync time is desired to reduce “smearing” due to the continuously moving paper. Typically an exposure time of no more than 25% of the row sync period results in a sharp image. A method of operating the SLM to meet these requirements, using multiple rows of the SLM to expose each line of print, is known as a “row integration” modulation method.

### SLM Modulation Methods

FIG. 4 illustrates a first modulation method used for an SLM-based photofinishing printer. This is a “row integration” modulation method, also known as Time Integration Gray scale (TIG) or Time Delay and Integrate (TDI).

FIG. 4 shows a simplified example of a section of photosensitive medium 41 as it passes through an exposure region 42 created by SLM 100. In the example of FIG. 4, SLM 100 is an array of LED elements. The outline of each LED element is shown from the backside of the array. Also shown is the outline of each pixel in the exposure region 42 on the photosensitive medium 41.

As the photosensitive material 41 reaches the first line of the exposure region 42 its first line of pixels is exposed by light from the first row 43 of SLM 100. Due to the transport speed of the photosensitive material 41, the first line receives only a limited duration of exposure from the first row 43 of the SLM 100 while it is in the first row of the exposure region 42. After being exposed by the first row of the SLM 100, the partially exposed portion of the photosensitive material 41 advances to the second line exposure location, where, assuming the image data for the pixel requires further exposure, the first line of pixels is further exposed by the second row of the SLM 100. As first row of the photosensitive material exposed by the first row of the SLM 100 is now exposed by the second row of the SLM, the next line of the photosensitive material 41 is exposed by the first row 812 of the SLM 100. This process continues as the photosensitive material 41 advances through the entire exposure region 42, allowing all of the rows of the SLM 100 an opportunity to expose each line of pixels on the photosensitive material 41. Pixels whose image data dictates an intermediate exposure are only actually exposed by some of the rows of the SLM 100. When row integration is the only form of modulation, each exposure of a given pixel by an element of the SLM 100 is equivalent to one LSB of the image data word for that pixel. Therefore, an N-row modulated light source is capable of exposing the photosensitive material with log₂(N) binary gray scale levels. Achieving 12-bits of gray scale with TIG modulation would require 4096 rows of modulator elements.

A second modulation method is Pulse Width Modulation (PWM). PWM varies the duty cycle of an SLM element during the row sync periods. Unfortunately, SLMs have a minimum duty cycle that limits the greyscale levels available with this method. For example, a DMD has a minimum cycle time of 17 mircoseconds. Thus, the least significant bit time for PWM is 17 mircoseconds. Exposing a pixel with 12-bits of image data would take 69.6 milleseconds per row. This is far longer than the 0.391 mircoseconds available to maintain a system throughput of 4800 4×6 prints per hour. Similarly, the minimum duty cycle for an LED is the time required to turn the diodes on and off; the greyscale level limitation for an LED would be calculated in a manner similar to that for a DMD.

Modulating the intensity of the light is a third modulation technique. Some SLMs allow the intensity of the light source to be varied on a pixel-by-pixel basis. For example, an LED array allows each LED in the array to output a different brightness level. Other SLMs allow the intensity of light striking the photosensitive material to be controlled, but not on a pixel-by-pixel basis. An alternative to controlling the output power of the SLM to vary the intensity of the light beam produced by a light source, such as by using one or more neutral-density filters in the light path.

For photofinishing, a combination of row integration and pulse width modulation methods has been determined to provide optimum greyscale resolution at acceptable printing speeds. U.S. patent Ser. No. 09/221,517, referenced above, describes such an approach. Various exposure algorithms are described, in which multiple exposure phases each have one of a number of predetermined durations. The described exposure algorithms implement combinations of exposures that can be provided by a succession of exposure phases. The patent also describes a method of including intensity modulation in the exposure algorithm.

In general, exposure is the sum of products of the number (N) of SLM rows used to expose the image, times the intensity (I) of exposure, times the exposure duration (D) for those rows. Thus,

Exposure=N1 I1 D1+N2 I2 D2+ . . . Nk Ik Dk

This suggests using a diversity of rows, intensities, and pulse widths may be used to create an exposure algorithm that results in a desired resolution at a desired process speed.

For purposes of discussion herein, an example exposure algorithm is used that has 192 exposure phases and four pulse widths. It provides 12-bit greyscale depth, although each of the 4096 greyscale levels need not be actually achieved, especially those at low levels. However, the algorithm minimizes the number of SLM rows required and maximizes transport speed. Examples of suitable pulse widths are pulse widths of 1.0, 1.1, 1.8, and 5.6 times the minimum DMD cycle time of 17 microseconds. The particular sequence of pulse widths, as well as the partitioning and arrangement of colors, can be optimized for optimal picture quality.

### Color Photofinishing

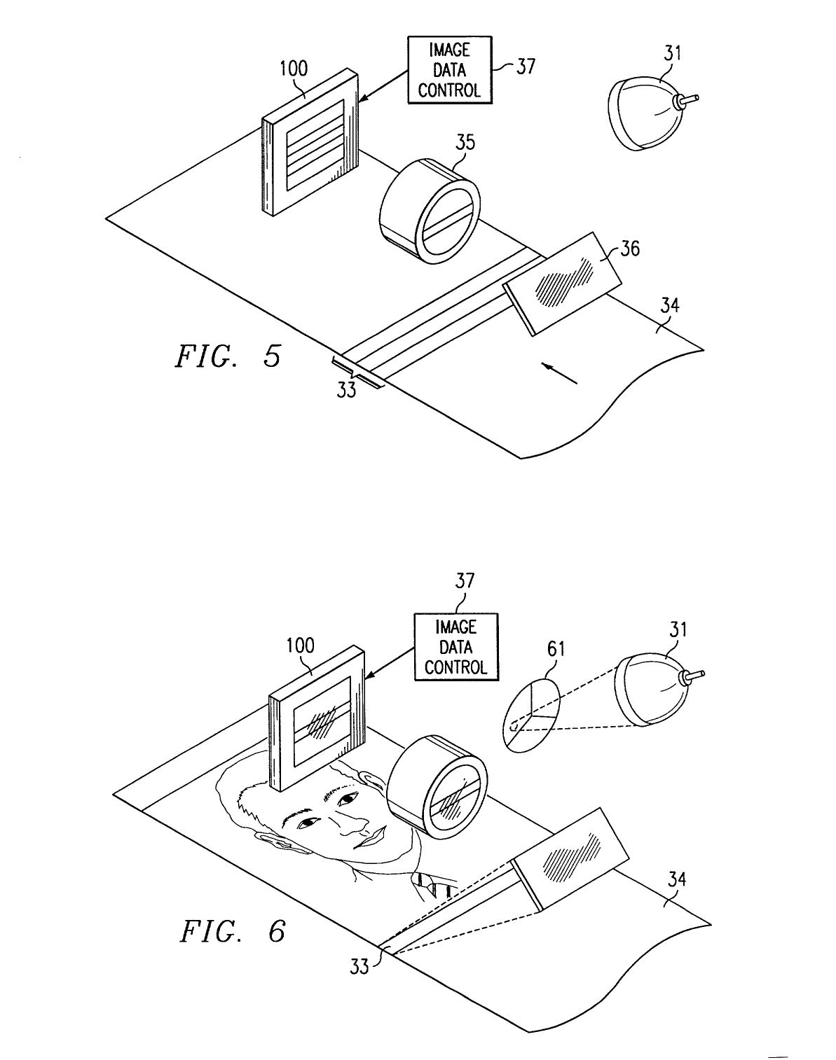

FIG. 5 illustrates the basic system of FIG. 3, with the addition of one method of providing color images. Three single-color images are created, with illumination wavelengths matched to the spectral response of the photosensitive medium. More specifically, the SLM 100 is divided into three groups of element arrays, each producing or controlling a unique single-color modulated beam of light. A first sub-group creates a red beam of modulated light, a second sub-group creates a green beam of modulated light, and a third sub-group creates a blue beam of modulated light. The sub-groups create a beam of modulated light either by emitting the modulated light or by modulating an incident beam of light. By way of example, and not by way of limitation, each of the three groups of elements could be a unique type of LED array capable of creating a unique color of light. Alternatively, each sub-group is a group of micromirror elements in combination with a color filter and illuminated by a white-light source. Yet another alternative uses a reflective or transmissive LCD array for each sub-group. The three-color SLM 100 exposes a continuous length of photosensitive material 34 as it moves in the process direction. The three regions of the SLM 100 each expose a separate exposure region on the photosensitive material 34.

FIG. 6 illustrates an alternative to the fixed color exposure system of FIG. 5. A color wheel 61 is spun in the illumination path of the exposure system. Light from light source 31, typically a tungsten lamp, is focused onto a very small region of the color wheel 61 so that light from the color wheel 61 is a single color a majority of the time. Although a transmissive color wheel 61 is shown, reflective color wheels may also be used. The color wheel 61 is spun, typically between 300 and 1100 revolutions per minute, and is synchronized to the movement in the process direction of the photosensitive material 34. According to one embodiment of a color wheel exposure system and modulation scheme, a n-row SLM 100 is used to expose a region of the photosensitive material n/3 times for each of three colors. The duration of one revolution of the color wheel 61 is equal to the length of the exposure region divided by the process speed. Thus, for an n-row exposure region 33, the time it takes a point on the photosensitive material 34 to traverse the exposure region 33 is equal to the time it takes the color wheel 61 to complete one revolution. In other embodiments, the colors may be partitioned throughout the 192 rows. For example, there might be eight rows of red, then eight rows of green, then eight rows of blue. The color wheel 61 would be rotated so that each segment is synchronized to the rows of the corresponding color. The color wheel could be multi-segmented or rotated faster, or some combination. In any of these embodiments, extra exposure phases may be added to the total exposure time, but not used, which allows the SLM 100 to be turned off during the spoke periods between color wheel segments.

### Control Electronics for Photofinishing System

Referring again to FIGS. 3, 5, and 6, an image data control unit 37 is used to provide data to the SLM. As explained below, control unit 37 implements an exposure algorithm for any type of SLM. Various buffers, a look-up table, and a controller implement the exposure algorithm; no processor is required. Various exposure algorithms may be accommodated, including those that use any of the three above-described modulation techniques or any combination of these techniques. The control unit 37 also provides synchronization to a continually moving photosensitive medium (or a fixed medium and scanning mirror arrangement).

Control unit 37 may be used in a photofinishing system that uses multiple light sources as described in connection with FIG. 5 (concurrent RGB), or with one that uses a color wheel as described in connection with FIG. 6 (sequential RGB). In the case of a color wheel system, control unit 37 provides synchronization for the color wheel. Control unit 37 may also be used with “hybrid” systems, where multiple SLMs are used in conjunction with a color wheel or other filtering system.

FIG. 7 is a block diagram of control unit 37. As explained below, control unit 37 satisfies the above-described system requirement for output resolution and throughput. In the example of this description, a throughput of at least 391 microseconds per line can be achieved. This throughput requires control unit 37 to process each row of the image in this time period, referred to herein as the “row sync” time.

Typically, the exposure algorithm implemented by control unit 37 uses a combination of modulation techniques. In the example of this description, the exposure algorithm uses both row integration and pulse width modulation. More specifically, each line of the output image may receive illumination from a possible 192 exposure phases, and each exposure phase may be one of four different pulse widths. Thus, an accumulation of 192 exposure phases, during which a given SLM element may be on or off, will result in a certain total exposure time for the associated pixel. This exposure algorithm permits a greyscale depth of 12 bits.

The source of the image data may be any digital source. For example, a scanner may be used to scan photographic negatives. The result is two-dimensional image data, where each n-bit value represents a pixel to be printed.

Image data transfer interface 71 provides the interface for transferring data from the source. For purposes of this description, an image size of 1280 pixels per row×1920 rows is assumed. This is equivalent to a 4×6 image with 320 dpi. A raster format orthogonal to the process direction is also assumed. The source data is also assumed to be RBG data with n-bits per color. A typical format is one entire red line, then a green line, then a blue line, but this format may vary, such as for a color wheel that is differently sequenced.

An example of a suitable interface 71 is the IEEE-1394 interface, which provides an interface from a 1394 serial bus. The 1394 bus is capable of a data rate of up to 400 Mbits per second, which satisfies the system requirement for transferring a new line of data every 391 microseconds (the row sync time). For example, where the source data has 16 bits per color, the transfer rate must be at least 158 Mbits per second (1280×16×3 bits).

As stated above, control unit 37 is designed for 12-bit (4096) greyscale levels. If the source data is more or fewer bits per pixel, interface 71 may include appropriate scaling means to map the source image data to the 4096 levels.

Frame buffer 72 stores the pixel data for the image to be printed. Buffer 72 may contain a portion of a frame, a complete frame, or more than one frame at a time. Frame buffer 72 is optional, where transfer interface 71 is sufficiently fast. For example, if interface 71 is a 1394 interface, is may be possible to deliver image data directly to row buffer 73.

Row buffer 73 stores a number of pixel rows equal to the number of rows used by the exposure algorithm. For example, for an exposure algorithm that uses 192 rows, row buffer stores 192 rows of pixel data. Each color may be exposed by 64 rows. Each pixel row in buffer 73 corresponds to a pixel row on the medium being exposed by SLM 100.

Buffer 73 is a “fall through” buffer. As a pixel row on the medium advances from one row of SLM 100 to the next, the position of the pixel row in buffer 73 advances to the next row in the buffer. The oldest row falls out of the buffer. Thus, each row remains in the row buffer for 192 row sync periods.

Look-up table (LUT) 74 is a memory that stores a table representing a particular exposure algorithm. In the example of this description, the exposure algorithm combines pulse width and row integration techniques and uses 192 rows and four pulse widths. However, LUT 74 could be loaded to implement other exposure algorithms, including one that uses intensity modulation.

In LUT 74, each pixel accesses a vector of on/off (binary) SLM settings. The length of the vector is equal to the number of exposure phases. Thus, in the example of this description where there are 192 exposure phases, each pixel accesses a vector of 192 values. Each value is 1 or 0, depending on whether the SLM element is to be on or off for that exposure phase. The number of vectors depends on the bit resolution. For example, for 12-bit pixels, there are 4096 vectors. In the simplest embodiment, LUT 74 has a width equal to the number of exposure phases and a length equal to the number of greyscale levels. Various alternative embodiments of LUT 74 are discussed below in connection with FIG. 12.

Settings buffer 75 provides storage for the on/off settings for the SLM 100. Each set of on/off settings is a “micro-image” for a single exposure phase of the SLM 100. Assuming that the SLM 100 has 192 rows (equal to the exposure region on the photographic medium), each micro-image is a set of 192×1280 binary values.

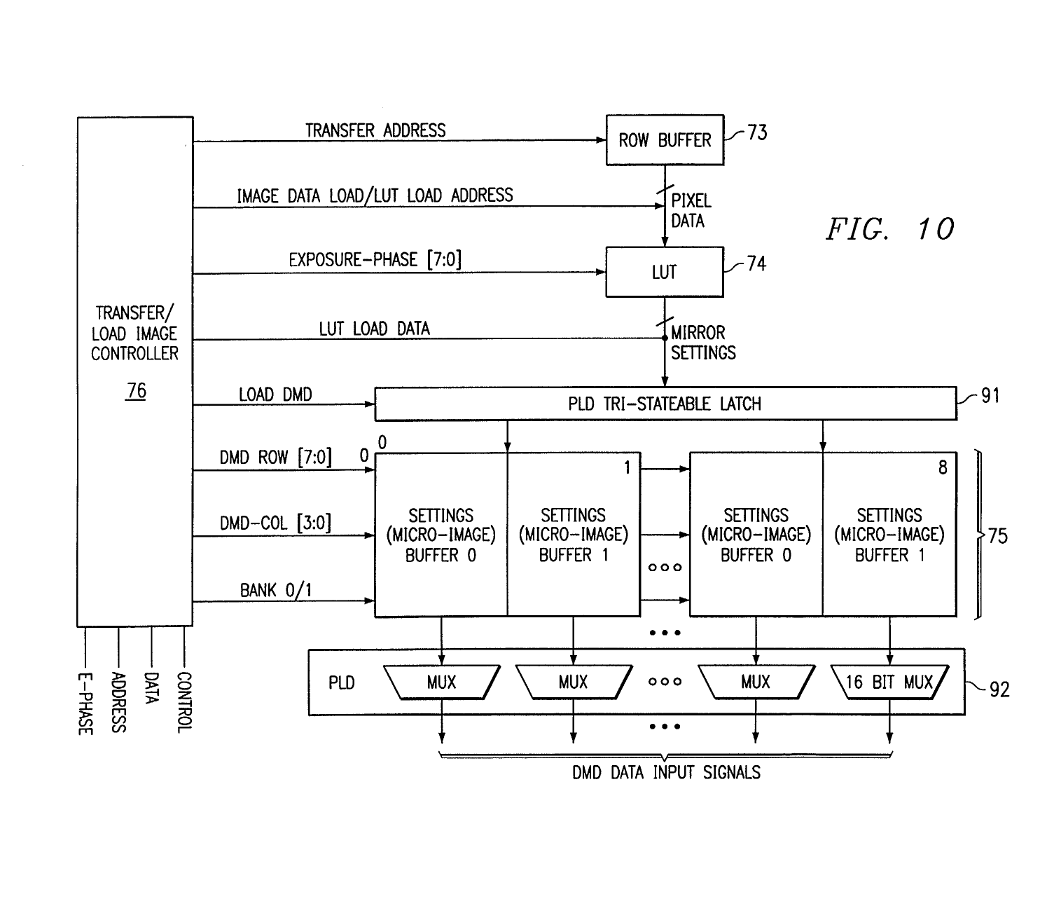

To meet system throughput requirements, settings buffer 75 may store more than one set of on/off settings. An example of settings buffer 75, where there are two ping-pong buffers each storing eight micro-images, is described below in connection with FIG. 10.

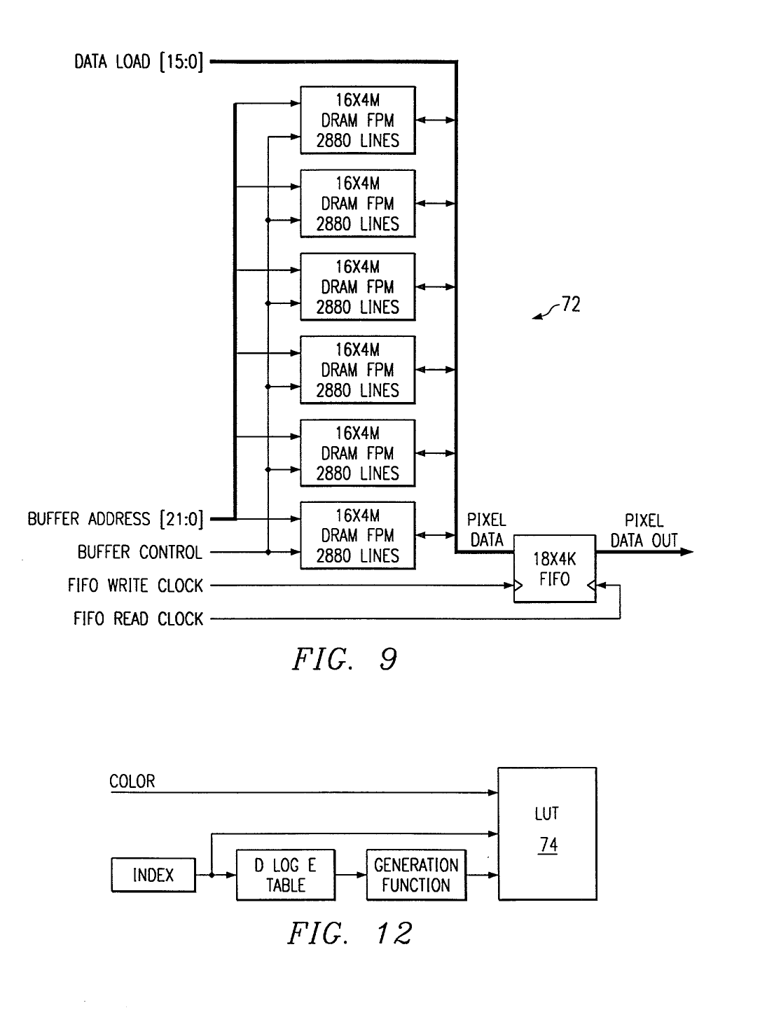

As explained below in connection with FIGS. 9 and 10, frame buffer 71 as well as the various reformatting elements (row buffer 73, LUT 74, and settings buffer 75) may be implemented with off the shelf memory chips.

Controller 76 controls the flow of pixel data through control unit 37. It cycles through all of the exposure phases, i.e., 0−191, incrementing the exposure phase every row sync. The exposure phase defines the pulse width (exposure time) and color for each exposure. Controller 76 provides signals to LUT 74, which determines the settings to be accessed for that exposure phase. Once the settings are loaded to SLM 100, controller 76 provides a pulse width signal to the SLM 100 that controls how long pixels are to be on during that exposure phase. It further provides various SLM row address and control inputs for loading and resetting the SLM 100.

Controller 76 also creates the signals needed to synchronize the paper transport to the image generation of the SLM 100. It receives a position indicator signal from the transport mechanism (not shown), which it uses for this purpose.

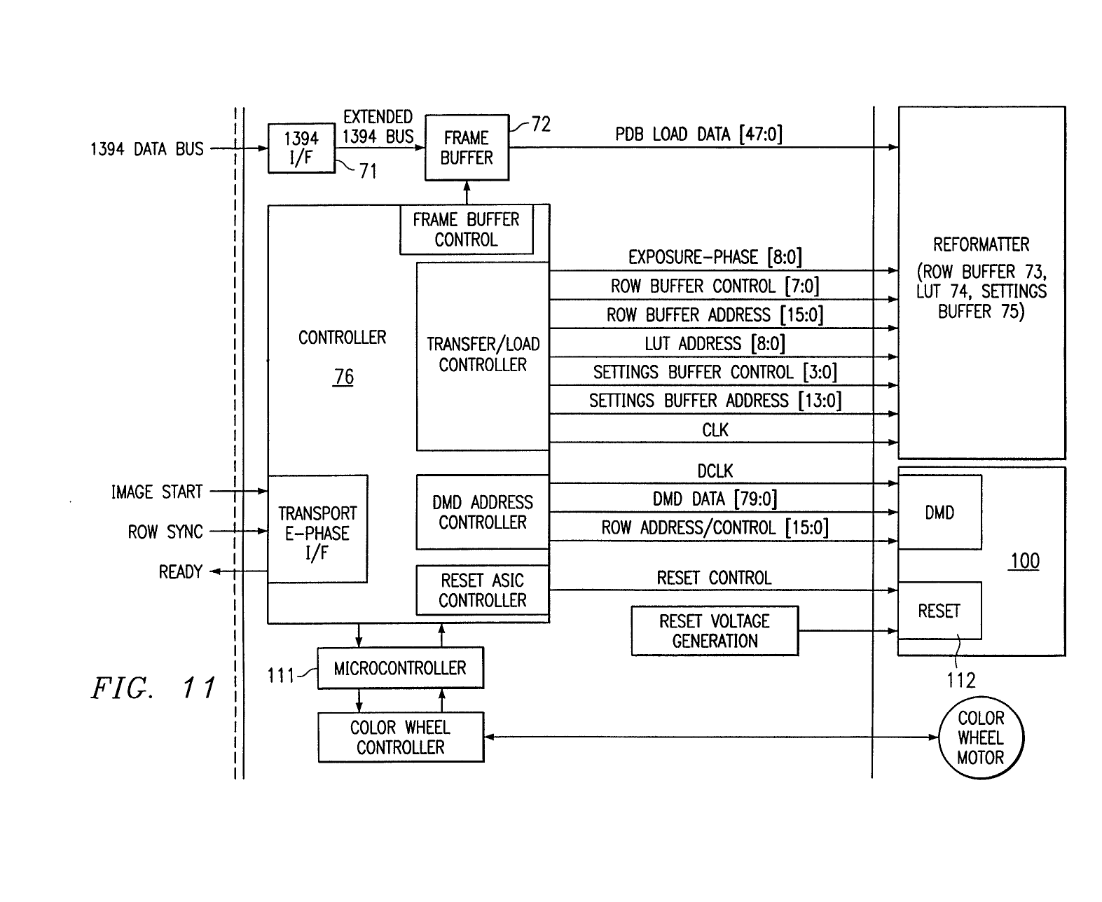

Controller 76 may be implemented with a field programmable gate array (FPGA). An example of an FPGA-implement controller 74 is described below in connection with FIG. 11.

Controller 76 further provides a power interface for control unit 37. It may provides multiple voltage supplies for different devices. For example, it might provide 5 volts for the SLM, 3.3 volts for buffer 73 and memory 75, and 12 volts for SLM reset and the color wheel motor.

FIG. 8 illustrates the data flow within image data control unit 37. As illustrated, pixel data is reformatted, one row at a time, into SLM settings. In the example of this description, an entire SLM micro-image is comprised of settings for 192 rows.

During each row sync period, row buffer 73 copies one line of pixel data from frame buffer 72, and moves the pixel data already stored from line to line. In the example of this description, the row sync period is constant, at a speed calculated to result in a certain printing rate. However, in other embodiments, the row sync may vary slightly in accordance with a synchronization scheme for synchronizing the SLM 100 and the transport of the photographic medium.

During each row sync time, the pixels in all rows are examined and converted to mirror settings. As stated above, each row of pixels to be printed has 192 exposure phases, one per row sync period, and each exposure phase has an associated pulse width. During a particular exposure phase, each SLM element is either on or off for that pulse width duration. Controller 76 delivers a signal to LUT 74 corresponding to the exposure phase, so that, for each pixel value, LUT 74 is accessed to determine whether the associated SLM element is to be on or off. In other words, a pixel value of xxxx during a particular exposure phase would access an appropriate row and column of LUT 74, resulting in the on or off setting for an SLM element during that exposure phase.

SLM settings buffer 75 stores the mirror settings for the new row as well as the settings for the previously stored rows. In the example of this description, settings buffer 75 stores settings for the new row and the previously stored 191 additional rows of the exposure region.

During each row sync period, a new micro-image of settings (192 rows×1280 pixels) must be loaded to the SLM 100. A method of storing multiple micro-images to accomplish system timing requirements is described below in connection with FIG. 10.

Each row sync period, the settings for a line of the image are advanced one row on the SLM 100 until that line is exposed 192 times. Controller 76 also controls the pulse width for each exposure phase, delivering a signal to SLM that determines how long its elements are to set (either on or off) during that exposure phase.

FIG. 9 illustrates an example of frame buffer 72. In the example of FIG. 9, buffer 72 is capable of storing three 6×4 inch 12-bit images. For each color, the sub-image for that color is 1280 pixels wide and has 1920 lines. Thus, each image is 5760 lines (3×1920), and buffer 72 stores 17,280 lines (5760×3) or 22 Mega pixels of data. This requires 44 Mbytes of memory. In FIG. 9, this is accomplished with six 16×4 Meg DRAM chips. Each chip stores 2880 lines of pixel data. In other embodiments, frame buffer 76 could be implemented with a DIMM module. Various control signals are delivered from controller 76. Clock signals are generated by a system timing unit (not shown).

FIG. 10 illustrates an example of the reformatting elements of control unit 37 (row buffer 72, LUT 74, and settings buffer 75). Each of these elements may be implemented with SRAM chips. Where control unit 37 is designed to 12-bit pixel data, 1280 columns, and 192 exposure rows, one suitable configuration is a set of five “boards” each having a buffer 73, LUT 74, and buffer 75 with a SRAM capacities of two 32×64 K, four 8×512 K, and four 32×8 K chips, respectively. Various control and addressing signals are delivered from controller 76. A first PLD (programmable logic device) 91 connects the LUT load data bus to the settings buffer data bus, and is implemented with tri-stateable latches. A second PLD 92 provides a data select from the settings buffer 75 for loading the SLM 100, and may be implemented with multiplexers.

Settings buffer 75 is configured as two buffers that operate in “ping-pong” mode. In other words, as one buffer is being loaded, the other is being read to SLM 100. Each of the two buffers stores eight micro images. After eight exposure phases, eight micro-images have been read, and the other buffer must be full.

Thus, each buffer is fully loaded with eight micro-images during eight exposure phases. To accomplish this, it obtains 24 rows of settings (8 settings per row) during each exposure phase. In one embodiment, where colors are “spread” throughout the 192 exposure phases, the 24 rows obtained during each exposure phase are eight of one color, then eight of a next color, then eight of the third color. Also, because the image being generated by the SLM 100 drops the 192d row and adds a new row during each exposure phase, the settings buffer must also provide SLM 100 the settings for each new row.

FIG. 11 illustrates an example of controller 76, configured for a photofinishing system that uses a color wheel 61, such as the system of FIG. 6. The SLM 100 of FIG. 11 is a DMD. Controller 76 cooperates with both a microcontroller 111 for color wheel control and a reset controller 112 for reset control. As illustrated, controller 76 receives various timing signals from a system timing unit (not shown), and delivers various timing and other control signals to SLM 100 (a DMD) and the reformatter elements (row buffer 73, LUT 74, and settings buffer 75).

### LUT Generation

LUT 74 and the pulse sequence followed by controller 76 are generated on the basis of various specifications. These include an exposure algorithm, a pixel size, and a density-to-illumination curve.

The exposure algorithm is a particular pulse sequence of exposure phases. In the example of this description, there are 192 exposure phases each having one of four pulse widths. However, many variations are possible. As indicated above, intensity modulation may also be used, such as with a color wheel having more than one segment for one or more colors.

The pixel size refers to how many bits of greyscale per color per pixel. Typical pixel sizes range from 8 bits to 12 bits per color.

The density-to-illumination curve is associated with the type of photographic medium to be used. Each type of medium has a specific response, which is non-linear. To compensate for the non-linear response, (referred to as a D log E curve), binary image data is scaled. This is necessary because the density (D) resulting on the finished print is a logarithmic function of the exposing light energy (log E). While many methods of scaling the image data are available, a lookup table is ideally suited to perform the necessary scaling. The input data is used as an address to access a location in the lookup table. The data stored at the accessed location is represents the scaled data and is output as a data word. Separate tables are used for red, blue, and green.

FIG. 12 illustrates the generation of LUT 74. The index value ranges from 0 to 2^{pixelsize} −1. To generate LUT 74, each possible input pixel value is first scaled in accordance with the D log E curve. For example, for 12-bit pixels, 4096 pixel values would be scaled. The generation function is called once for each index value; each pixel value is associated with a particular pulse sequence. For example, the most intense value, that is, the value represented by 4095, would be assigned a pulse sequence where all exposure phases are on, and the accumulation of all pulse widths during all phases would result in maximum exposure. The result is an array of on/off settings that are written to the LUT 74.

In one embodiment, the LUT address is a function of color and an index value. Where there are 192 exposure phases (64 per color), the index value is 0-63. Red, blue, and green mirror settings are interleaved in the LUT 74. If the exposure sequence is the same for each color, LUT 74 need only be 4096 entries long and 64 entries wide, with each exposure phases repeating the same settings three times. Typically, however, each exposure phase will vary depending on color.

### Other Embodiments

Although the present invention has been described in detail, it should be understood that various changes, substitutions, and alterations can be made hereto without departing from the spirit and scope of the invention as defined by the appended claims.

What is claimed is:

1. An image data control unit for an SLM-based photofinishing system that produces images based on source pixel data, each line of the image being exposed with multiple rows of the SLM, one line being exposed during each exposure phase, comprising:
a row buffer that stores a number of rows of source pixel data, each value of the source pixel data representing a greyscale level;
a look-up memory that stores a table of SLM settings, indexed by greyscale levels and exposure phases;
a controller that generates an exposure phase signal for each exposure phase, each exposure phase signal providing access to the look-up memory to obtain an SLM setting value corresponding to a greyscale value and an exposure phase, and further generates control signals for operating the SLM; and
a settings buffer that receives settings from the look-up memory and stores them for delivery to the SLM.

2. The image data control unit of claim 1, wherein the controller further generates a pulse width signal to the SLM that determines the duration of each exposure phase.

3. The image data control unit of claim 1, wherein the settings buffer is double buffer, operable to provide settings to the SLM in a ping-pong manner.

4. The image data control unit of claim 1, wherein the settings buffer stores multiple micro-images, each micro-image representing the settings for each element of the SLM.

5. The image data control unit of claim 1, wherein the look-up memory stores the same settings for all colors.

6. The image data control unit of claim 1, wherein the look-up memory stores different settings for each color.

7. The image data control unit of claim 1, wherein the controller further provides synchronization control signals for a color wheel.

8. The image data control unit of claim 1, wherein the controller is implemented with logic elements.

9. The image data control unit of claim 1, further comprising a frame buffer for storing pixel data for delivery to the row buffer.

10. The image data control unit of claim 1, further comprising a transfer interface for receiving the source pixel data into the control unit.

11. A method of using an SLM-based photofinishing system to expose an exposure region on a photographic medium with images based on source pixel data, each line of the printed image being exposed with multiple exposure phases of the SLM, comprising the steps of:
storing a number of rows of source pixel data, each value of the source pixel data representing a greyscale level;
accessing a look-up memory that stores a table of SLM settings, indexed by greyscale levels and exposure phases;
generating an exposure phase signal for each exposure phase, each signal providing access to the look-up memory to obtain a setting value corresponding to a greyscale value and an exposure phase;
generating control signals for operating the SLM;
storing settings for a number of rows of the SLM;
loading the SLM with settings; and
exposing the exposure region of the image.

12. The method of claim 11, wherein each exposure phase occurs during a row sync period.

13. The method of claim 11, wherein the exposure region is smaller than the image to be printed, the medium is moving relative to the SLM, and the above steps are repeated until the image is entirely exposed.

14. The method of claim 11, wherein the image is exposed with illumination filtered by a color wheel, and further comprising the steps of synchronizing the above steps with operation of the color wheel.

15. The method of claim 11, wherein the accessing step is performed such that a number of settings for each pixel are obtained during each access of the look-up memory, and settings for a number of rows are stored during each exposure phase.

16. An exposure unit for an SLM-based photofinishing system that produces images based on source pixel data, each line of the image being exposed with multiple rows of the SLM, one new line being exposed during each exposure phase, comprising:
a row buffer that stores a number of rows of source pixel data, each value of the source pixel data representing a greyscale level;
a look-up memory that stores a table of SLM settings, indexed by greyscale levels and exposure phases;
a controller that generates an exposure phase signal for each exposure phase, each exposure phase signal providing access to the look-up memory to obtain an SLM setting value corresponding to a greyscale value and an exposure phase, and further generates control signals for operating the SLM;
a settings buffer that receives settings from the look-up memory and stores them for delivery to the SLM; and
at least one spatial light modulator that generates an exposure image during each exposure phase in accordance with settings stored in the settings buffer.

17. The exposure unit of claim 16, wherein the SLM is a digital micro-mirror device.

18. The exposure unit of claim 16, further comprising a color wheel for filtering light illuminating the SLM.

19. The exposure unit of claim 18, wherein the color wheel has different segments for different colors and different intensities.

20. The exposure unit of claim 1, wherein the at least one SLM generates images for different colors concurrently.
